(19) United States
(12) Patent Application Publication
(10) Pub. No.: US 2014/0218488 A1
(43) Pub. Date: Aug. 7, 2014

(54) METHODS AND DEVICE FOR PROCESSING DIGITAL STEREO IMAGE CONTENT

(71) Applicants: Piotr Didyk, Saarbrucken (DE); Tobias Ritschel, Saarbrucken (DE); Elmar Eisemann, Delft (NL); Karol Myszkowski, Saarbrucken (DE); Hans-Peter Seidel, Saarbrucken (DE)

(72) Inventors: Piotr Didyk, Saarbrucken (DE); Tobias Ritschel, Saarbrucken (DE); Elmar Eisemann, Delft (NL); Karol Myszkowski, Saarbrucken (DE); Hans-Peter Seidel, Saarbrucken (DE)

(73) Assignees: Max-Planck-Gesellschaft zur Forderung der Wissenschaften e.V, Munchen (DE); UNIVERSITAT DES SAARLANDES, Saarbrucken (DE)

(21) Appl. No.: 14/118,197

(22) PCT Filed: May 18, 2012
(86) PCT No.: PCT/EP2012/059301

§ 371 Date: Apr. 3, 2014

Related U.S. Application Data
(60) Provisional application No. 61/486,846, filed on May 17, 2011.

(30) Foreign Application Priority Data
May 17, 2011 (EP) 11166448.8

(51) Int. Cl. G06T 7/00

(52) U.S. Cl. CPC G06T 7/0075; G06T 7/002
USPC 348/51; 382/154

(57) ABSTRACT

According to the invention, a computer-implemented method for processing digital stereo image content, comprises the steps of estimating a perceived disparity of the stereo image content and processing the stereo image content, based on the estimated perceived disparity.

The present invention relates to the processing of digital stereo image content.

### TECHNICAL BACKGROUND AND PRIOR ART

Stereoscopic or stereo images are increasingly used in many computer graphics contexts, including virtual reality and movies. Whenever stereo images are synthesized or processed, it is desirable to control the effect that the synthesis or processing has on the perceived quality of the stereo image, most particularly on the depth of the image perceived by a human viewer.

The human visual system (HVS) relies on a large variety of depth cues, which can be categorized as pictorial information (occlusions, perspective foreshortening, relative and familiar object size, texture and shading gradients, shadows, aerial perspective), as well as, dynamic (motion parallax), ocular (accommodation and vergence), and stereoscopic information (binocular disparity). The HVS exhibits different sensitivity to these depth cues (which may strongly depend on the object's distance to the eye and integrates the occasionally contradictory information. Dominant cues may prevail or a compromise 3D scene interpretation (in terms of cues likelihood) is perceived.

Stereopsis is one of the strongest and most compelling depth cues, where the HVS reconstructs distance by the amount of lateral displacement (binocular disparity) between the object's retinal images in the left and right eye. Through vergence both eyes can be fixated at a point of interest (e. g., F in FIG. 1), which is then projected with zero disparity onto corresponding retinal positions.

FIG. 1 shows a schematic diagram of binocular perception.

The disparity at P for the fixation point F is measured as the difference of vergence angles ω−θ. In the field of computer vision, the term disparity describes a lateral distance (e. g., in pixels) of a single object inside two images. The following description will use “disparity” in the sense of perception literature and data, while “pixel disparity” refers to the vision definition. Only horizontal disparities shall be considered as they have stronger contribution to the depth perception than other, e. g. vertical disparities.

Retinal images can be fused only in the region around the horopter, called Panum's fusional area, and otherwise double vision (diplopia) is experienced. The fusion depends on many factors such as individual differences, stimulus properties (better fusion for small, strongly textured, well-illuminated, static patterns), and exposure duration.

Stereopsis can be conveniently studied in isolation from other depth cues by means of so-called random-dot stereograms. The disparity detection threshold depends on the spatial frequency of a corrugated in-depth pattern with peak sensitivity around 0.3-0.5 cpd (cycles-per-degree). The disparity sensitivity function (DSF) has an inverse “u”-shape with a cut-off frequency around 3 cpd. Also, for larger-amplitude (suprathreshold) corrugations, the minimal disparity changes that can be discriminated (discrimination thresholds) exhibit a Weber's Law-like behavior and increase with the amplitude of corrugations. Disparity detection and discrimination thresholds are increasing when corrugated patterns are moved away from the zero-disparity plane. The larger the pedestal disparity (i. e., the further the pattern is shifted away from zero-disparity), the higher are such thresholds.

Apparent depth is dominated by the distribution of disparity contrasts rather than absolute disparities, which is similar to apparent brightness, which is governed by contrasts rather than absolute luminance. While the precise relationship between apparent depth and disparity features is not fully understood, depth is perceived most effectively at surface discontinuities and curvatures, where the second order differences of disparity are non-zero. This means that binocular depth triggered by disparity gradients (as for slanted planar surfaces) is weak and, in fact, dominated by the monocular interpretation. As confirmed by the Craik-O'Brien-Cornsweet illusion for depth, where a strong apparent depth impression arises at sharp depth discontinuities and is maintained over regions where depth is actually decaying towards equidistant ends. Recently, it was found that effects associated with lateral inhibition of neural responses (such as Mach bands, the Hermann grid, and simultaneous contrast illusions) can be readily observed for disparity contrast [(LUNN, P., AND MORGAN, M. 1995. The analogy between stereo depth and brightness: a reexamination. Perception 24, 8, 901-4).

It is an object of the invention to provide a method and a device for processing digital stereo image content predicting the perceived disparity from stereo images.

### SHORT SUMMARY OF THE INVENTION

This object is achieved by the methods and device according to the independent claims. Advantageous embodiments are defined in the dependent claims.

According to one aspect of the invention, a computer-implemented method for processing digital stereo image content comprises the steps of estimating a perceived disparity of the stereo image content; and processing the digital stereo image content, based on the estimated perceived disparity.

Digital stereo image content may comprise digital images or videos that may be used for displaying stereo images and may be defined by luminance and pixel disparity, a depth map and an associated color image or video or any other kind of digital representation of stereo images.

The perceived disparity of the stereo image may be estimated based on a model of a disparity sensitivity of the human visual system (HVS).

### BRIEF DESCRIPTION OF THE FIGURES

These and other aspects and advantages of the present invention will become more evident when considering the following detailed description of an embodiment of the present invention, in connection with the annexed drawing, in which

FIG. 1 shows a schematic diagram of human binocular perception.

FIG. 2 shows how pixel disparity is converted into a perceptually uniform space according to an embodiment of the invention.

FIG. 3 shows, from top to bottom/left to right: (1) Disparity magnitude ranges:

(red) maximum disparity used in experiments of the inventors, (yellow) diplopia and (blue) maximum disparity limits. (2) The experimental setup where subjects select the sinusoidal gratings which exhibits more depth. (3) A fit to the disparity discrimination threshold function Ad(s). (4) The cross section of the fit at the most sensitive disparity frequency 0.3 cpd (the error bars denote the standard error of the mean (SEM) at measurement locations). (5) Analogous cross section along frequency axis showing the detection thresholds. Both cross sections are marked with white dashed lines in (3). (6) The transducer functions for selected frequencies. Empty circles denote the maximum disparity limits.

FIG. 4 shows disparity detection and discrimination thresholds for shutter glasses as a function of the spatial frequency of disparity corrugations for different corrugation amplitudes as specified in the legend. Points drawn on curves indicate the measurement samples. The error bars denote the standard error of the mean (SEM); and

FIG. 5 shows a comparison of disparity detection and discrimination thresholds for three different stereo devices.

FIG. 6 shows a processing pipeline for computing a perceptual disparity difference metric according to an embodiment of the invention;

FIG. 7 shows a perceptual disparity compression pipeline according to an embodiment of the invention.

FIG. 8 shows an example of a backward compatible stereo image that provides just-enough disparity cues to perceive stereo, but minimizes visible artifacts when seen without special equipment;

FIG. 9 shows an example of hybrid stereo images: nearby, it shows the BUDDHA; from far away, the GROG model;

FIG. 10 illustrates the effect of using the Cornsweet Illusion for depth.

### DETAILED DESCRIPTION

Starting from an original depth map a pixel disparity map is computed and then a disparity pyramid is built. After multi-resolution disparity processing, the dynamic range of disparity is adjusted and the resulting enhanced disparity map is produced. The map is then used to create an enhanced stereo image.

The original depth map of the digital stereo image content is a linearized depth buffer that has a corresponding color image. Based on this depth information, a disparity map may be obtained that defines the stereo effect of the stereo image content. To obtain the disparity map, the linearized depth is first converted into pixel disparity, based on a scene to world mapping. The pixel disparity is converted to a perceptually uniform space, which also provides a decomposition into different frequency bands. The inventive approach acts on these bands to yield the output pixel disparity map that defines the enhanced stereo image pair. Given the new disparity map, one may then warp the color image according to this definition.

First, a scene unit is fixed that scales the scene such that one scene unit corresponds to a world unit. Then, given the distance to the screen and the eye distance of the observer, this depth is converted into pixel disparity.

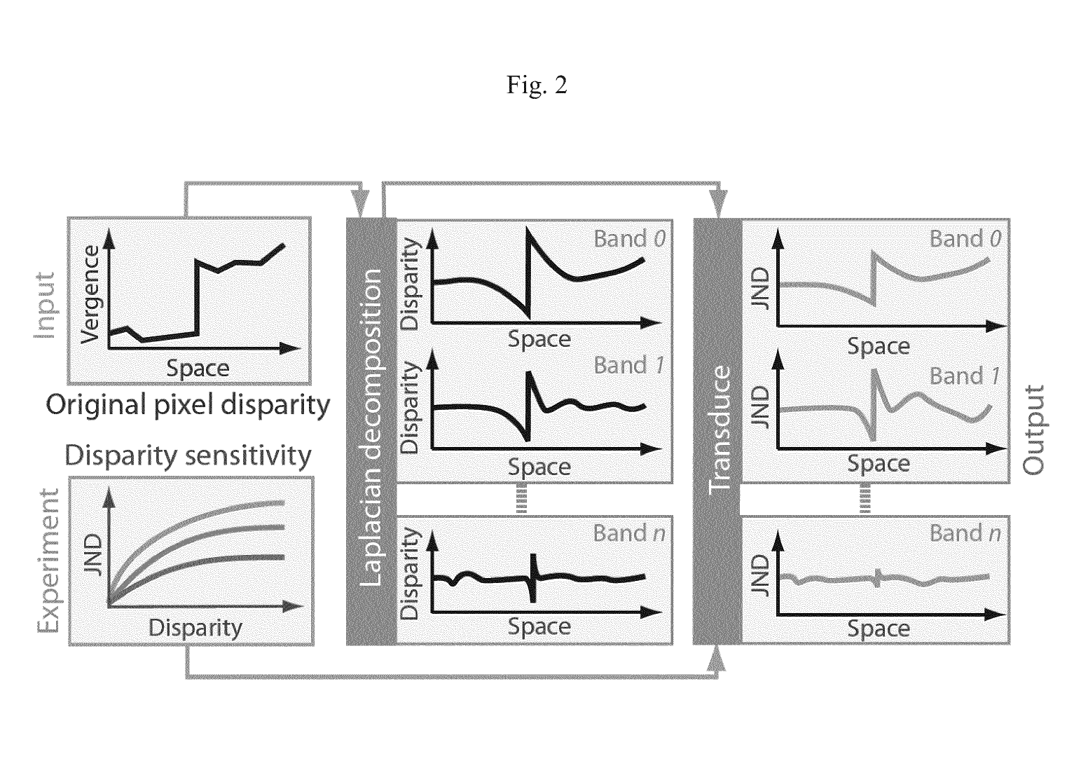

FIG. 2 shows how pixel disparity is converted into a perceptually uniform space according to an embodiment of the invention.

The pipeline estimates the perceived disparity decomposed into a spatial-frequency hierarchy that models disparity channels in the HVS. Such spatial-frequency selectivity is usually modeled using a hierarchal filter bank with band-pass properties such as wavelets, Gabor filters, Cortex Transform, or Laplacian decomposition (BURT, P. J., AND ADELSON, E. H. 1983. The laplacian pyramid as a compact image code. IEEE Trans. on Communications). According to the present embodiment of the invention, a Laplacian decomposition is chosen, mostly for efficiency reasons and the fact that the particular choices of commonly used filter banks should not affect qualitatively the quality metric outcome.

First, the pixel disparity is transformed into corresponding angular vergence, taking the 3D image observation conditions into account. Next, a Gaussian pyramid is computed from the vergence image. Finally, the differences of every two neighboring pyramid levels are computed, which results in the actual disparity frequency band decomposition. In practice, a standard Laplacian pyramid with 1-octave spacing between frequency bands may be used. Finally, for every pixel value in every band, a transducer function for this band maps the corresponding disparity to JND units. In this way, the perceived disparity may be linearized. The advantage of this space is that all modifications are predictable and uniform because the perceptual space provides a measure of disparity in just-noticeable units. It, hence, allows a convenient control over possible distortions that may be introduced by a user. In particular, any changes below 1JND should be imperceptible.

Using the estimated perceived disparity, the stereo image may then be processed or manipulated. To convert perceived disparity, back into a stereo image, an inverse pipeline is required. Given a pyramid of perceived disparity in JND, the inverse pipeline produces again a disparity image by combining all bands.

In order to implement disparity transducers for selected frequencies of corrugated spatial patterns, e.g. in the form of a look-up table, some disparity detection data may be used that is readily available (BRADSHAW, M. F., AND ROGERS, B. J. 1999. Sensitivity to horizontal and vertical corrugations defined by binocular disparity. Vision Res. 39, 18, 3049-56; TYLER, C. W. 1975. Spatial organization of binocular disparity sensitivity. Vision Res. 15, 5, 583-590; see HOWARD, I. P., AND ROGERS, B. J. 2002. Seeing in Depth, vol. 2: Depth Perception. I. Porteous, Toronto, Chapter 19.6.3 for a survey). More advantageously, the disparity transducers may be based on precise detection and discrimination thresholds covering the full range of magnitudes and spatial frequencies of corrugated patterns that can be seen without causing diplopia. According to the invention, these may be determined experimentally. In order to account for intra-channel masking, disparity differences may be discriminated within the same frequency.

Free eye motion may be allowed in the experiments, making multiple fixations on different scene regions possible, which approaches real 3D-image observations. In particular, one wants to account for a better performance in relative depth estimation for objects that are widely spread in the image plane (see Howard and Rogers 2002, Chapter 19.9.1 for a survey on possible explanations of this observation for free eye movements). The latter is important to comprehend complex 3D images. In the experiments, it may be assumed that depth corrugated stimuli lie at the zero disparity plane (i. e., observers fixate corrugation) because free eye fixation can mostly compensate for any pedestal disparity within the range of comfortable binocular vision (LAMBOOIJ, M., IJSSELSTEIJN, W., FORTUIN, M., AND HEYNDERICKX, I. 2009. Visual discomfort and visual fatigue of stereoscopic displays: A review. J. Imaging Science and Technology 53, 3, 1-12; HOFFMAN, D., GIRSHICK, A., AKELEY, K., AND BANKS, M. 2008. Vergence-accommodation conflicts hinder visual performance and cause visual fatigue. J. Vision 8, 3, 1-30). Such zero-pedestal disparity assumption guarantees that one conservatively measures the maximum disparity sensitivity [Blakemore 1970], which in such conditions is similar for uncrossed (positive, i. e., ω−θ>0 as in FIG. 2) and crossed (negative) disparities (Howard and Rogers 2002, FIG. 19.24 c, op. cit.). For this reason it is assumed in what follows that only disparity magnitude matters in the transducer derivation.

The experiments according to the invention measure the dependence of perceived disparity on two stereo image parameters: disparity magnitude and disparity frequency. Variations in accommodation, viewing distance, screen size, luminance, or color are not accounted for and all images are static. Disparity Frequency specifies the spatial disparity change per unit visual degree. This is different from the frequencies of the underlying luminance, which will be called luminance frequencies. The following disparity frequencies were considered by the inventors: 0.05, 0.1, 0.3, 1.0, 2.0, 3.0 cpd.

A pilot study by the inventors experimented with more extreme frequencies, but the findings proved less reliable (consistent with [Bradshaw and Rogers 1999]). Disparity magnitude corresponds to the corrugation pattern amplitude. The range of disparity magnitude for the detection thresholds to suprathreshold values that do not cause diplopia have been considered, which were determined in the pilot study for all considered disparity frequencies. While disparity differences over the diplopia limit can still be perceived up to the maximum disparity, the disparity discrimination even slightly below the diplopia limit is too uncomfortable to be pursued with naïve subjects. To this end, it was decreased explicitly, in some cases, significantly below this boundary. After all, it is assumed that the data will be mostly used in applications within the disparity range that is comfortable for viewing.

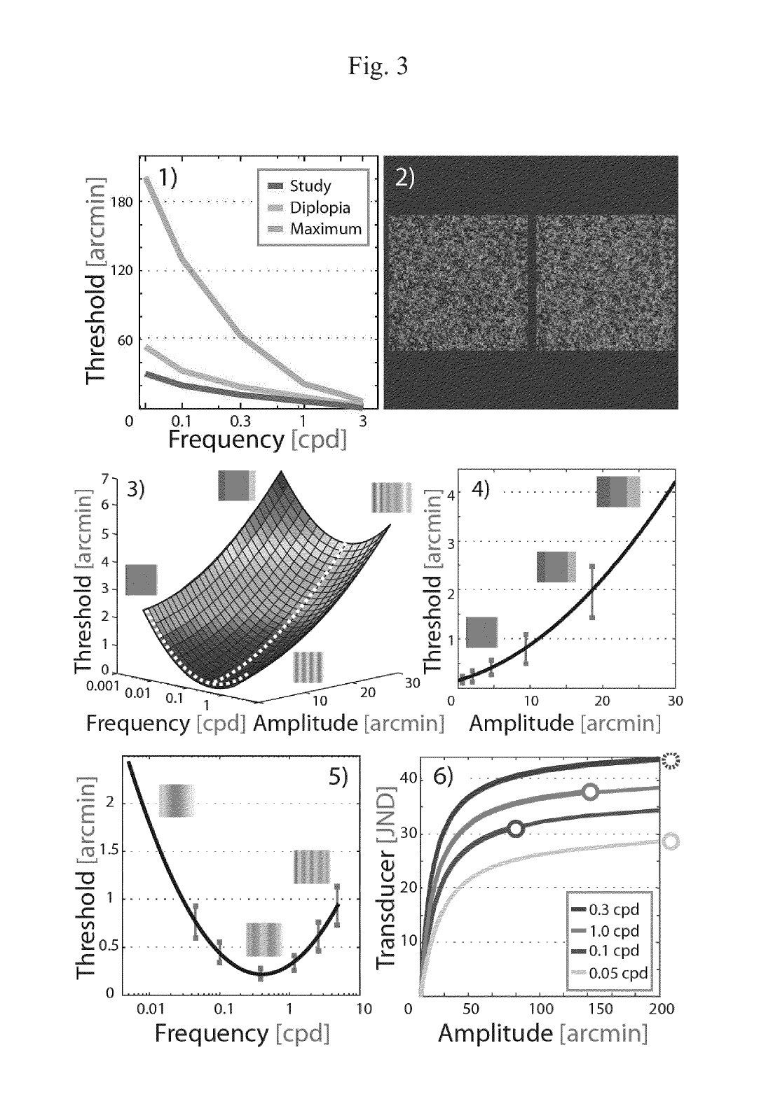

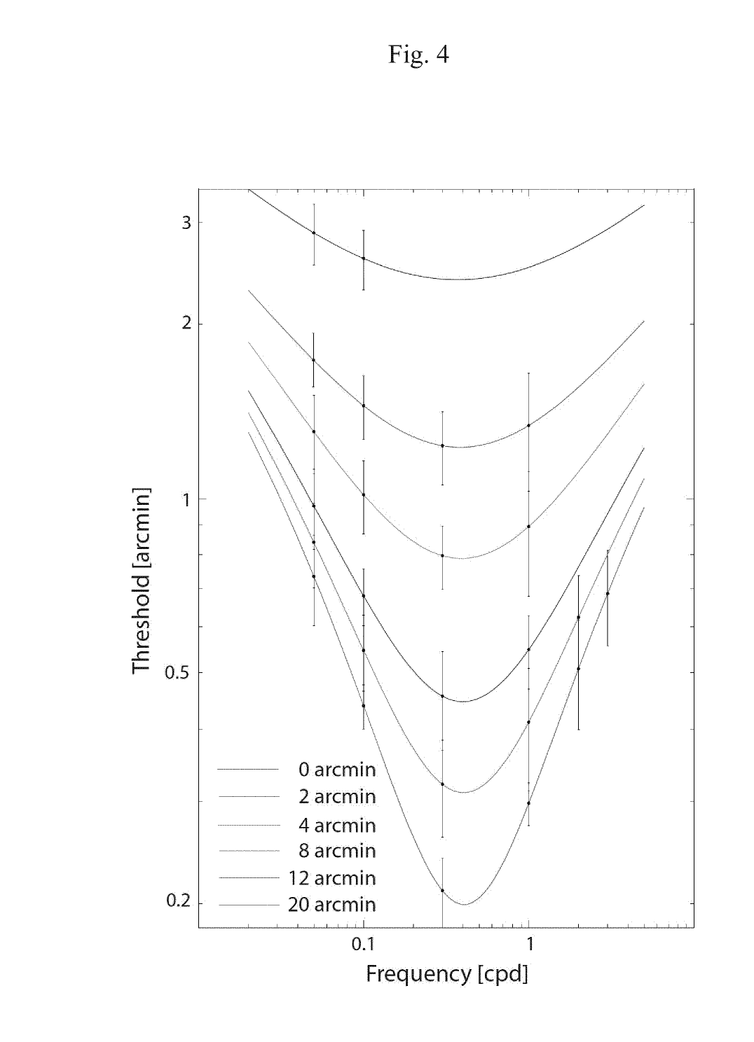

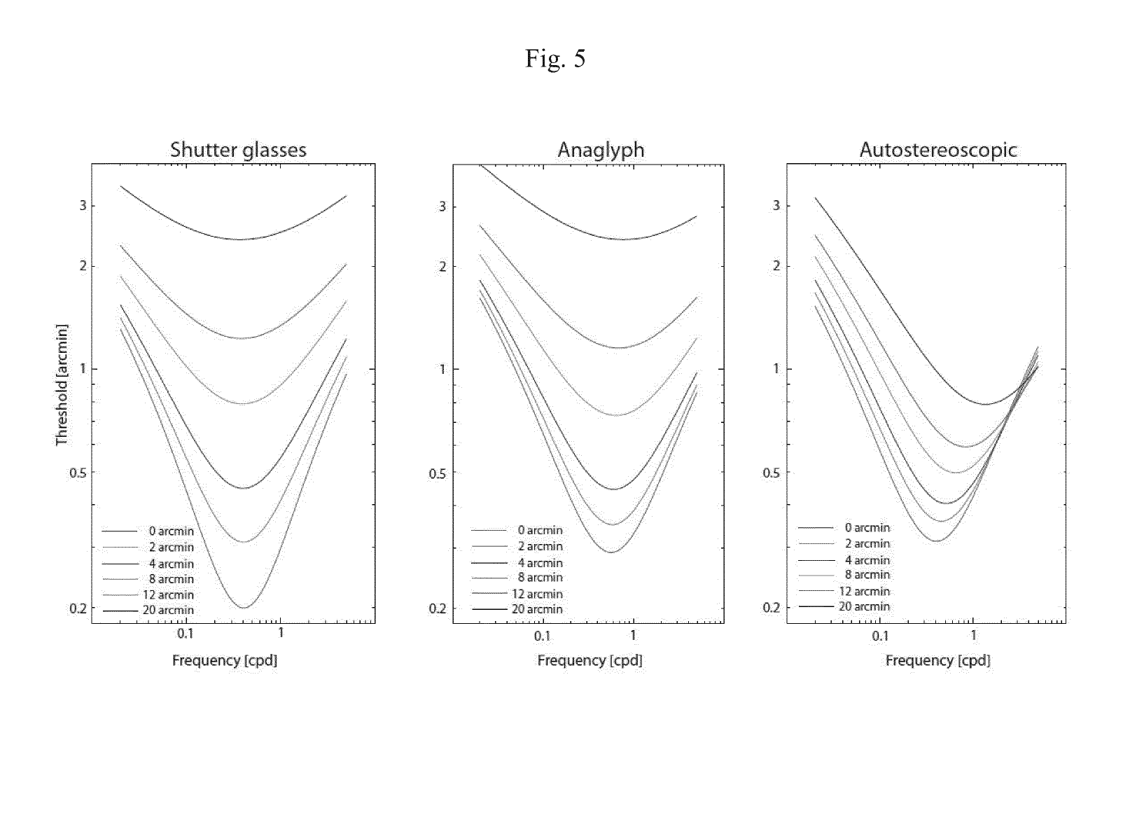

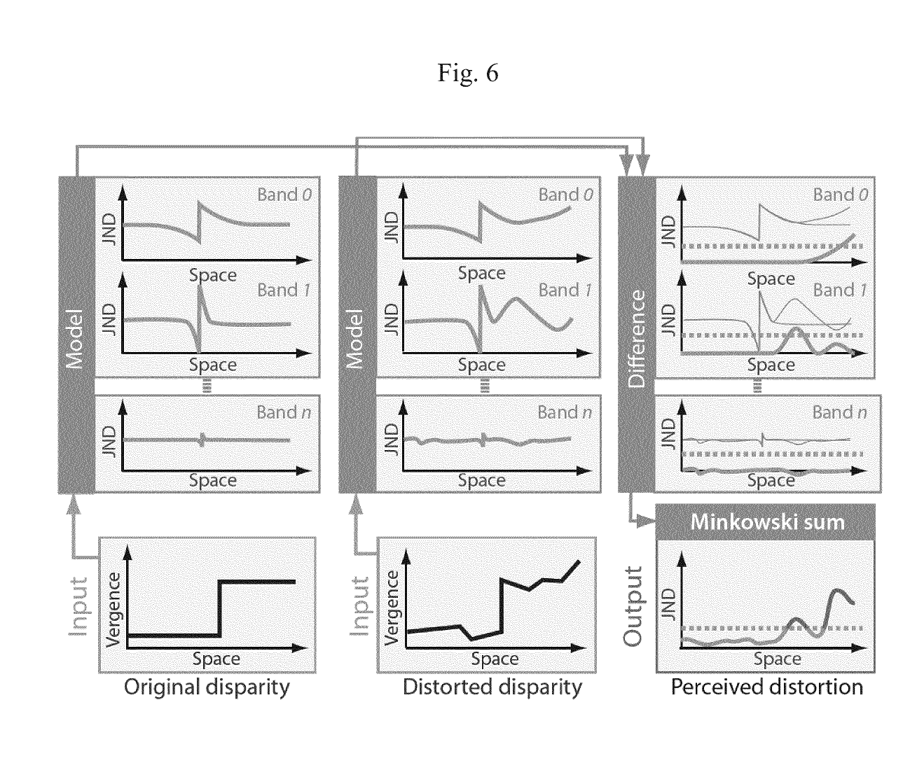

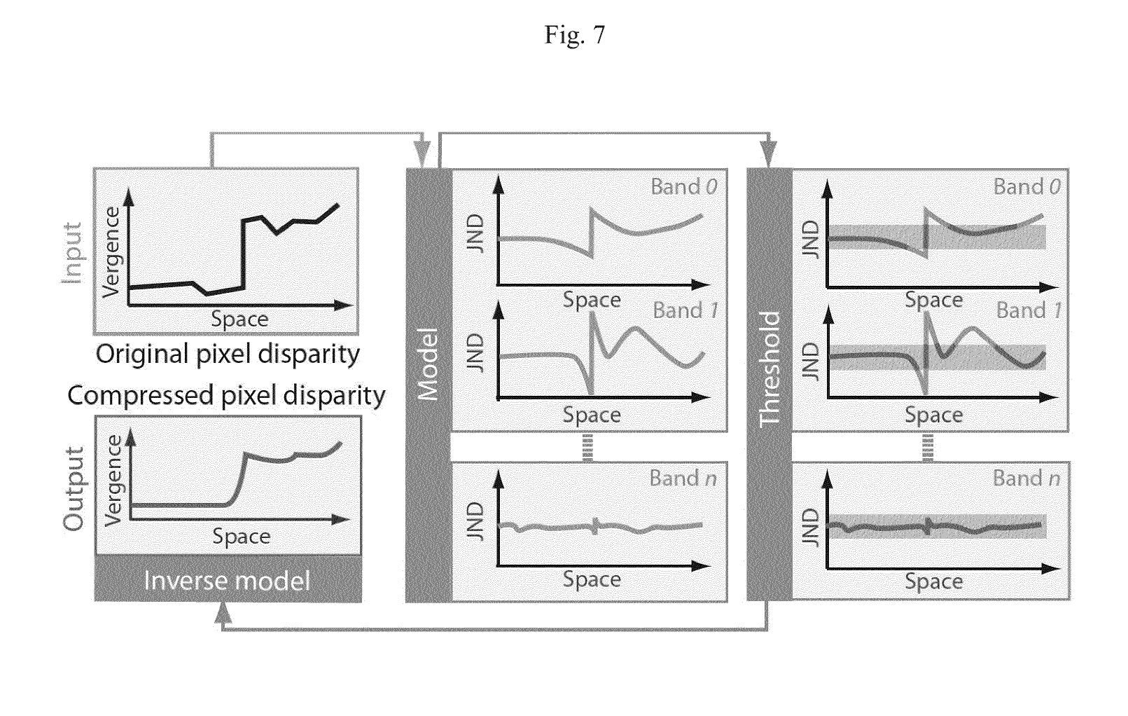

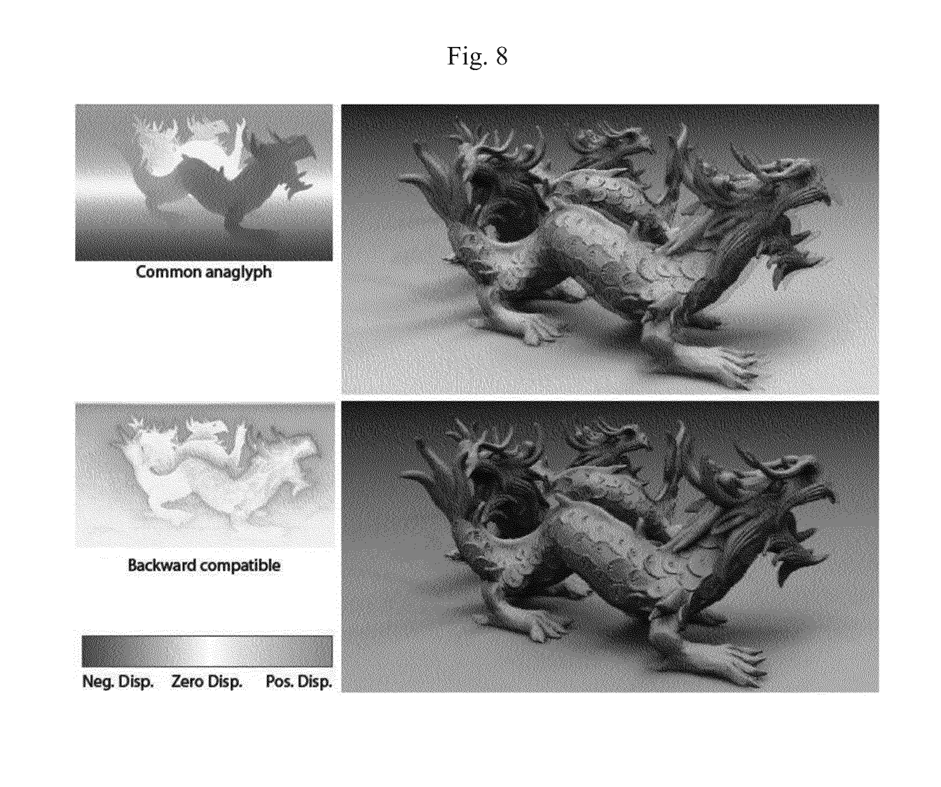

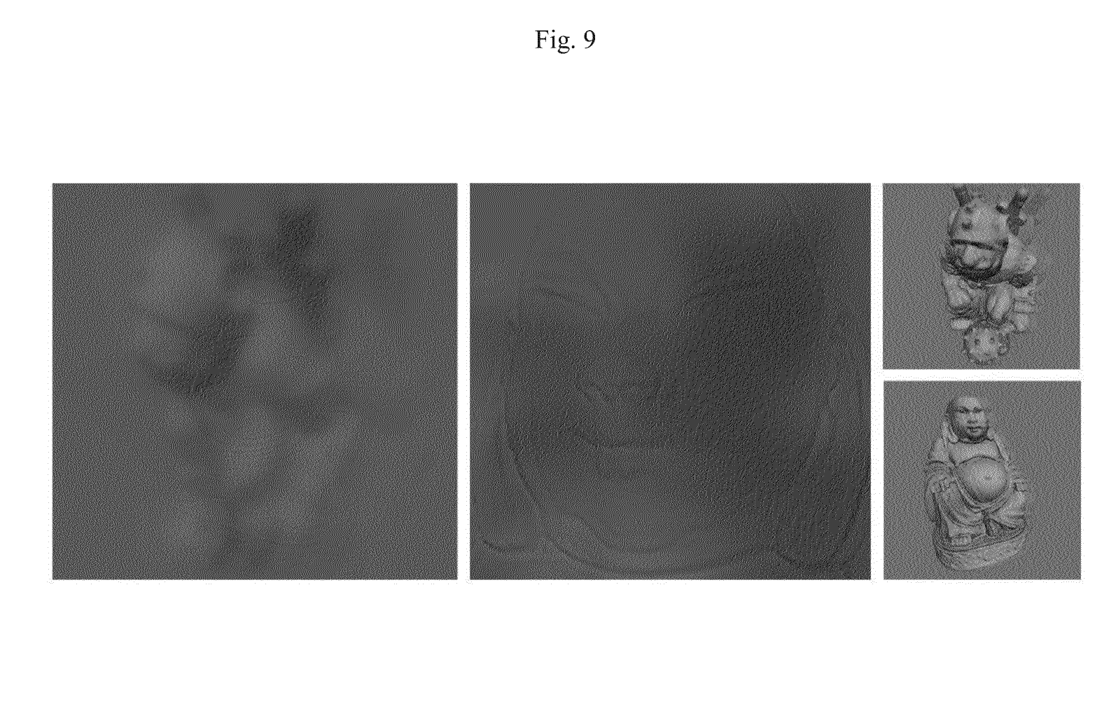

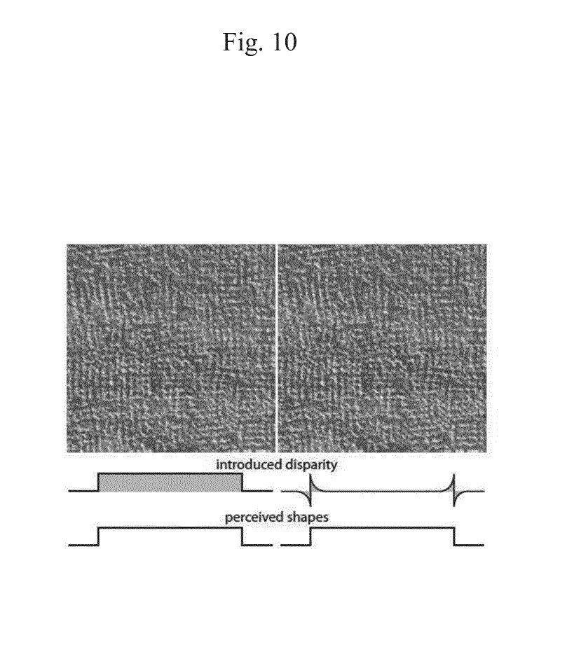

FIG. 3(1) shows the measured diplopia and maximum disparity limits, as well as the effective range disparity magnitudes considered in the experiments.

All stimuli are horizontal sinusoidal gratings with a certain amplitude and frequency with a random phase. Similarly to existing experiments, the disparity is applied to a luminance pattern consisting of a high number of random dots, minimizing the effect of most external cues (e. g., shading). A cue that could influence the measurements is texture density. However, as one seeks to measure 1 JND, subjects always compare patterns with very similar amplitudes. Therefore, the difference in texture density between two stimuli is always unperceivable and does not influence detection thresholds. Formally, a stimulus s ∈ [symbol] ² may be parameterized in two dimensions (amplitude and frequency). The measured discrimination threshold function Δd(s): S→ [symbol] maps every stimulus within the considered parameter range to the smallest perceivable disparity change.

An image-based warping may be used to produce both views of the stimulus independently. First, the stimulus' disparity map D is converted into a pixel disparity map Dp, by taking into account the equipment, viewer distance, and screen size. Standard intra-ocular distance of 65 mm was assumed, which is needed for conversion to a normalized pixel disparity over subjects. Next, the luminance image is traversed and every pixel L(x) from location x ∈ [symbol] ² is warped to a new location x±(Dₚ(x),0)^{T} for the left, respectively right eye. As occlusions cannot occur for these stimuli, warping produces artifact-free valid stimuli. To ensure sufficient quality, super-sampling may be used: Views are produced at 4000² pixels, but shown as 1000²-pixel patches, down-sampled using a 4² Lanczos filter.

Three representative forms of stereo equipment may be used: active shutter glasses, anaglyph glasses and an autostereoscopic display. Nvidia 3D Vision active shutter glasses (˜$100) in combination with a 120 Hz, 58 cm diagonal Samsung SyncMaster 2233RZ display (˜$300, 1680×1050 pixels) were used, observed from 60 cm. As a low-end solution, this setup was also used with anaglyph glasses. Further, a 62 cm Alioscopy 3DHD24 auto-stereoscopic screen ($6000, 1920×1080 pixels total, distributed on eight views of which two were used) was employed. It is designed for an observation distance of 140 cm. Unless otherwise stated, the results are reported for active shutter glasses.

In the experiment, Δd was sampled at locations S={sᵢ|sᵢ∈ S} by running a discrimination threshold procedure on each to evaluate Δd(sᵢ). A two-alternative forced-choice (2AFC) staircase procedure is performed for every sᵢ. Each staircase step presents two stimuli: one defined by sᵢ the other as sᵢ+(ε;0)^{T} , which corresponds to a change of disparity magnitude. Both stimuli are placed either right or left on the screen (FIG. 3.2), always randomized. The subject is then asked which stimulus exhibits more depth amplitude and to press the “left” cursor key if this property applies to the left otherwise the “right” cursor key. After three correct answers ε is decremented and after a single incorrect answer it is incremented by the step-size determined via PEST (Parameter Estimation by Sequential Testing, cf. TAYLOR, M., AND CREELMAN, C. 1967. PEST: Efficient estimates on probability functions. J. Acoustical Soc. America 41, 782).

In total 27 PEST procedures have been performed per subject. Twelve subjects participated in the study with the shutter glasses and four subjects with each other setup of stereo equipment (anaglyph and auto-stereoscopy). Each subject completed the experiment in 3-4 sessions of 20-40 minutes. Four subjects repeated the experiment twice for different stereo equipment.

The data from the previous procedure was used to determine a model of perceived disparity by fitting an analytic function to the recorded samples. It is used to derive a transducer to predict perceived disparity in JND (just noticeable difference) units for a given stimulus which is the basis of a stereo difference metric according to the invention.

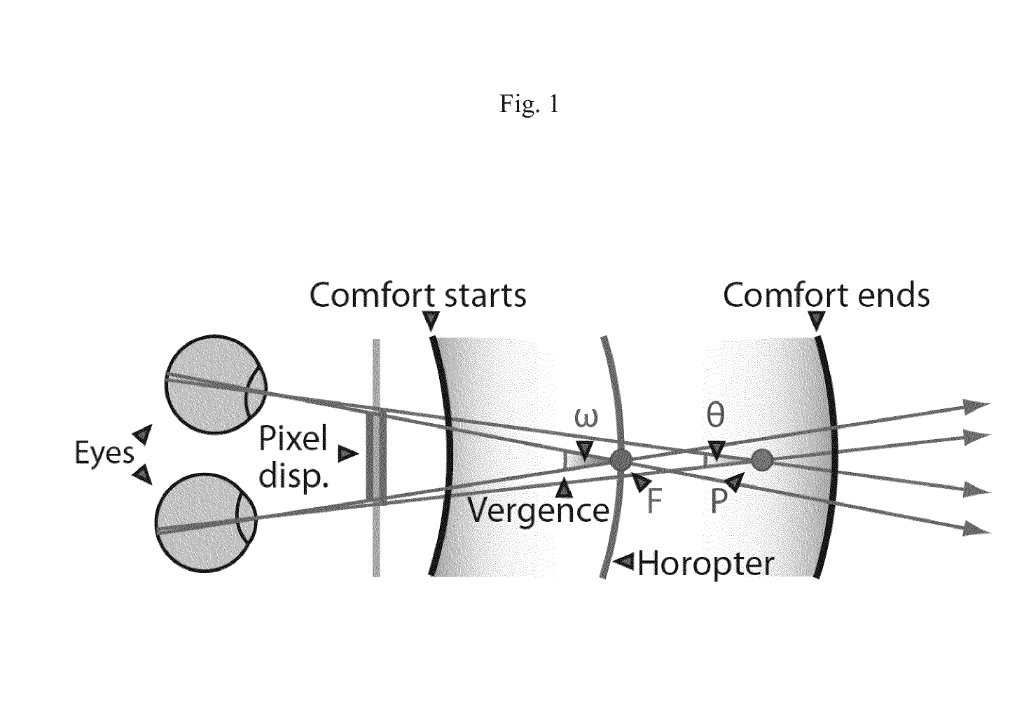

To model the thresholds from the previous experiment, a two-dimensional function of amplitude a and frequency f may be fitted to the data (FIG. 3.3-5). Quadratic polynomials with a log-space frequency axis may be used to well fit (the goodness of fit R²=0.9718) the almost quadratic “u”-shape measured previously (Bradshaw and Rogers 1999, FIG. 1):

Δd()=Δd(a,f)≈0.2978+0.0508a+0.5047 log₁₀(f)+0.002987a²+0.002588a log₁₀(f)+0.6456 log₁₀(f).

Based on this function, a set of transducer functions may be derived which map a physical quantity x (here disparity) into the sensory response r in JND units. Each transducer t_{f} (x): [symbol] ⁺→ [symbol] ⁺ corresponds to a single frequency f and is computed as t_{f} (x)=∫₀^{x}(Δd(a,f))¹da. Δd is positive, t_{f} (x) is monotonic and can be inverted, leading to an inverse transducer t_{f}¹(r), that maps a number of JNDs back to a disparity. For more details on transducer derivation refer to Wilson (WILSON, H. 1980. A transducer function for threshold and suprathreshold human vision. Biological Cybernetics 38, 171-8) or Mantiuk et al. (MANTIUK, R., MYSZKOWSKI, K., AND SEIDEL, H. 2006. A perceptual framework for contrast processing of high dynamic range images. ACM Trans. Applied Perception 3, 3, 286-308).

Limiting disparity magnitudes below the diplopia limits in the experiments has consequences. The Ad(s) fit is, strictly seen, only valid for this measured range. Consequently, transducers (FIG. 3.6) have to rely on extrapolated information beyond this range. While the transducer functions look plausible, they should actually remain flat beyond the maximum disparity limits, which are denoted as empty circles in FIG. 3.6. In those regions it is enforced that the overall increase of the transducers remains below a one-JND fraction, reflecting that depth perception becomes impossible, but securing the invertibility of the function. In practice, one may rely on a family of transducers T_{f} discretized using numerical integration and inverse transducers T_{f} ¹ found by inversion via searching. All transducers may be pre-computed (FIG. 3.6) and stored as look-up tables.

The inventors considered three different stereo technologies: shutter and anaglyph glasses as well as auto-stereoscopic display.

FIGS. 4 and 5 summarize the obtained data for each type of equipment in discrimination threshold experiments. For each set of data, the discrimination threshold function, which is denoted as dₛ, d_{ag}, dₐₛ was fitted for shutter glasses, anaglyph and autostereoscopic display respectively:

Δdₛ(f,a)=0.2978+0.0508a+0.5047 log₁₀(f)+0.002987a²+0.002588a log₁₀(f)+0.6456 log₁₀²(f).

Δd_{ag}(f,a)=0.3304+0.01961a+0.315 log₁₀(f)+0.004217a²−0.008761a log₁₀(f)+0.6319 log₁₀²(f).

Δdₐₛ(f,a)=0.4223+0.007576a+0.5593 log₁₀(f)+0.0005623a²−0.03742a log₁₀(f)+0.7114 log₁₀²(f).

where f is a frequency and a is an amplitude of disparity corrugation.

For all devices the minimum disparity sensitivity was found for ˜0.4 cpd, which agrees with previous studies [Bradshaw and Rogers 1999]. The inventors demonstrate applications considering shutter glasses, as this is the most commonly used solution (cf. FIG. 5). Although for anaglyph glasses higher detection thresholds are obtained (cf. FIG. 6), the overall the shape of discrimination threshold functions for larger disparity magnitudes is similar as for shutter glasses.

Measurements for auto-stereoscopic display revealed large differences with respect to shutter and anaglyph glasses. This may be due to much bigger discomfort, which was reported by the test subjects. Also measurements for such displays are more challenging due to difficulties in low spatial frequency reproduction, which is caused by relatively big viewing distance (140 cm) that needs to be kept by a observer. The disparity sensitivity drops significantly when less than two corrugations cycles are observed due to lack of spatial integration, which might be a problem in this case. It was observed that measurements for disparity corrugations of low spatial frequencies are not as consistent as for higher frequencies and they differ among subjects.

Surprisingly, the experiments seem to indicate that for larger disparity magnitudes the disparity sensitivity is higher for the auto-stereoscopic display than for other stereo technologies investigated.

FIG. 6 shows a processing pipeline for computing a perceptual disparity difference metric according to an embodiment of the invention. Based on the inventive model, one can define a perceptual stereo image metric. Given two stereo images, one original D^{o} and one with distorted pixel disparities D^{d}, it predicts the spatially varying magnitude of perceived disparity differences. To this end, both D^{o} and D^{d} may be inserted into the pipeline shown in FIG. 7. First, the perceived disparity Ro is computed respectively R^{d}. This is achieved using original pipeline from FIG. 3 with an additional phase uncertainty step, before applying per-band transducers. This eliminates zero crossings at the signal's edges and thus prevents incorrect predictions of zero disparity differences at such locations. In practice, a 5×5 Gaussian low-pass filter may be used at every level of our Laplacian pyramid and compensate for the resulting amplitude loss, which is a part of the calibration procedure (below). Then, for every pixel i; j and each band k the difference R_{i,j,k}^{o,d}=R_{i,j,k}^{o}−R_{i,j,k}^{d} is computed and finally combined using a Minkowski summation:

$${d}_{i , j} = {( {\sum }_{k} {\vert {R}_{i , j , k}^{o , d} \vert}^{β} )}^{\frac{1}{β}} ,$$

where β, found in the calibration step, controls how different bands contribute to the final result. The result is a spatially-varying map depicting the magnitude of perceived disparity differences.

In the metric, all frequency bands up to 4 cpd may be considered, which cover the full range of visible disparity corrugation frequencies and higher-frequency bands may be ignored. The intra-channel disparity masking is modeled because of the compressive nature of the transducers for increasing disparity magnitudes.

A metric calibration may be performed to compensate for accumulated inaccuracies of the model. The most serious problem is signal leaking between bands during the Laplacian decomposition, which offers also clear advantages. Such leaking effectively causes inter-channel masking, which conforms to the observation that the disparity channel bandwidth of 2-3 octaves might be a viable option. This justifies relaxing frequency separation between 1-octave channels such as we do. While decompositions with better frequency separation between bands exist such as the Cortex Transform, they preclude an interactive metric response. Since signal leaking between bands as well as the previously described phase uncertainty step may lead to an effective reduction of amplitude, a corrective multiplier K may be applied to the result of the Laplacian decomposition.

To find K and calibrate the metric the invention uses data obtained experimentally (above). As reference images, the experiment stimuli described above for all measured disparity frequencies and magnitudes were used. As distorted images, the corresponding patterns with 1, 3, 5, and 10 JNDs distortions were considered. The magnitude of 1 JND distortion directly resulted from the experiment outcome and the magnitudes of larger distortions are obtained using our transducer functions. The correction coefficient K=3.9 lead to the best fit and an average metric error of 11%. Similarly, the power term β=4 was found in the Minkowski summation.

First, the need of having different transducers for different bands was tested. This is best seen when considering the difference between two Campbell-Robson disparity patterns of different amplitudeComparing the inventive metric and a metric, where the same transducer for all bands is used, shows that the inventive metric correctly takes into account how the disparity sensitivity depends on the pattern frequency. The inventive method correctly reports the biggest difference in terms of JNDs for frequencies to which the HVS is most sensitive to (i. e., 0.4 cpd). Using only one transducer is still beneficial comparing to not using it, which in such a case would result in a uniform distortion reported by the metric.

Next, it was checked whether subthreshold distortions as predicted by the inventive metric cannot be seen, and conversely whether over threshold distortions identified by our metric are visible. Three versions were prepared of each stimulus: a reference, and two copies with a linearly scaled disparity, which our metric identifies as 0.5 JND and 2 JND distortions. In a 2AFC experiment, the reference and distorted stereo images were shown and subjects were asked to indicate the image with larger perceived depth. Five subjects took part in the experiment where stimuli have been displayed 10 times each in a randomized order. For the 0.5 JND distortion the percentage of correct answers falls into the range 47-54%, which in practice means a random choice and indicates that the distorted image cannot be distinguished from the reference. For the 2 JND distortion the outcome of correct answers was as follows: 89%, 90%, and 66% for the scenes GABOR, TERRAIN, and FACTORY, respectively. The two first results fall in the typical probability range expected for 2 JND [Lubin 1995] (the PEST procedure asymptotes are set at the level 79%, equivalent to 1 JND [Taylor and Creelman 1967]). On the other hand, for FACTORY the metric overestimates distortions, reporting 2 JND, while they are hardly perceivable. The repeated experiment for this scene with 5 JND distortion lead to an acceptable 95% of correct detection. The results indicate that our metric correctly scales disparity distortions when disparity is one of the most dominating depth cues. For scenes with greater variety of depth cues (e. g., occlusions, perspective, shading), perceived disparity is suppressed and the inventive metric can be too sensitive. The t-test analysis indicates that the distinction between 0.5 and 2 JND stimuli is statistically significant with p-value below 0.001 for the GABOR and TERRAIN scenes. For FACTORY such statistically significant distinction is obtained only between 2 and 5 JND stimuli.

The experiments dealt with suprathreshold luminance contrast as well as threshold and suprathreshold disparity magnitudes, so related disparity—contrast signal interactions are naturally accounted by the inventive model. Instead of adding two more dimensions (spatial frequency and magnitude of luminance contrast) to the experiment, existing inaccuracies of the inventive model may be tolerated for near threshold contrast, due to the nature of the described applications, dealing mostly with supra threshold disparity contrast signals. Temporal effects may also be ignored, although they are not only limited to high-level cues, but also present in low-level pre-attentive structures. Furthermore, the above-described measurements were performed for an accommodation onto the screen, which is a valid assumption for current equipment, but might not hold in the future. The measurements consider only horizontal corrugations, while the stereoscopic anisotropy (lower sensitivity to vertical corrugations) can be observed for spatial corrugations below 0.9 cpd, but the inventive metric could easily accommodate for anisotropy by adding orientation selectivity into the inventive channel decomposition.

Besides the perceived disparity difference assessment, the invention may be applied to a number of problems like stereo content compression, re-targeting, personalized stereo, hybrid images, and an approach to backward-compatible stereo.

Global operators that map disparity values to new disparity values globally, can operate in the perceptually uniform space of the invention, and their perceived effect can be predicted using the inventive metric. To this end, disparity may be converted into perceptually uniform units via the inventive model. Then, it may be modified and converted back.

Histogram equalization can use the inventive model to adjust pixel disparity to optimally fit into the perceived range. Again, after transforming into the space of the invention, the inverse cumulative distribution function c⁻¹(y), may be built on the absolute value of the perceived disparity in all levels of the Laplacian pyramid and sampled at the same resolution. Then, every pixel value y in each level, at its original resolution may be mapped to sgn(y)c⁻¹(y), which preserves the sign.

Warping may be used to generate image pairs out of a single (or a pair of) images. In order to avoid holes, a conceptual grid may be warped instead of individual pixels (DIDYK, P., RITSCHEL, T., EISEMAN, E., MYSZKOWSKI, K., ANDSEIDEL, H.-P. 2010. Adaptive image-based stereo view synthesis. In Proc. VMV). Further, to resolve occlusions a depth buffer may be used: If two pixels from a luminance image map onto the same pixel in one view, the closest one is chosen. All applications, including the model, run on graphics hardware at interactive rates.

When displaying stereo content with a given physical disparity, its perception largely depends on the viewing subject and the equipment used. It is known that stereoacuity varies drastically for different individuals, even more than for luminance. According to the invention, an average model may be used, derived from the data obtained during experiments. Although it has the advantage of being a good trade-off in most cases, it can significantly over- or underestimate discrimination thresholds for some users. This may have an impact especially while adjusting disparity according to user-preferences. Therefore, the inventive model provides the option of converting perceived disparity between different subjects, between different equipment, or even both. To this end, a transducer acquired for a specific subject or equipment may convert disparity into a perceptually uniform space. Applying an inverse transducer acquired for another subject or equipment then achieves a perceptually equivalent disparity for this other subject or equipment.

Non-linear disparity-retargeting allows matching pixel disparity in 3D content to specific viewing conditions and hardware, and provides artistic control (LANG, M., HORNUNG, A., WANG, O., POULAKOS, S., SMOLIC, A., AND GROSS, M. 2010. Nonlinear disparity mapping for stereoscopic 3D. ACM Trans. Graph. (Proc. SIGGRAPH) 29, 4, 75:1-10.). The original technique uses a non-linear mapping of pixel disparity, whereas with the inventive model, one can work directly in a perceptual uniform disparity space, making editing more predictable. Furthermore, the difference metric of the invention can be used to quantify and spatially localize the effect of a retargeting

More particularly, digital stereo image content may be retargeted by modifying the pixel disparity to fit into the range that is appropriate for the given device and user preferences, e.g. distance to the screen and eye distance. Typically, such retargeting implies that the original reference pixel disparity D^{r} is scaled to a smaller range D^{s}, whereby some of the information in D^{s} may get lost or become invisible during this process. According to the invention, adding Cornsweet profiles Pᵢ to enhance the apparent depth contrast may compensate this loss.

As the perceptual decomposition is performed using a Laplacian pyramid, the bands correspond to Cornsweet profile coefficients, wherein each level is a difference of two Gaussian levels, which remounts to unsharp masking.

Hence, modifying higher bands in the pyramid remounts to modifications in form of Cornsweet profiles. E.g., adding the sum of these higher bands would directly yield unsharp masking. In practice, it is a good choice to only involve the top five bands of the perceptual decomposition to add the lost disparities. The loss of disparity in D^{s} with respect to D^{r} is estimated by comparing the disparity change in each band of a Laplacian pyramid:

Rᵢ=Cᵢ^{T}−Cᵢ^{S}

where Rᵢ are the corrections in a given band i, Cᵢ^{r} and Cᵢ^{s} are the bands of the reference and distorted disparity respectively.

In theory, one might be tempted to simply add all Rᵢ directly on top of D^{s}. Effectively, this would add Cornsweet profiles to the signal, but care has to be taken that the resulting pixel disparity does not create disturbing deformation artifacts and remains within the given disparity bounds. In order to prevent disturbing distortions, the Cornsweet profiles are limited directly in the perceptual space; the corrections Rᵢ may be manipulated. A first observation is that all values are in JND units; hence, the maximum influence of the Cornsweet profiles may be limited by clamping individual coefficients in Rᵢ so they do not exceed a limit given in JND units. Clamping is a good choice, as the Laplacian decomposition of a step function exhibits the same maxima over all bands situated next to the edge, is equal zero on the edge itself, and decays quickly away from the maxima. Because each band has a lower resolution with respect to the previous, clamping of the coefficients lowers the maxima to fit into the allowed range, but does not significantly alter the shape. The combination of all bands together leads to an approximate smaller step function, and, consequently, choosing the highest bands leads to a Cornsweet profile of limited amplitude.

Unfortunately, this will not yet ensure that the enhancement layer R (composed of all Rᵢ) combined with D^{s} will not result in too large value. Clamping is a straightforward way of limiting the profiles R, but it results in at areas whenever the disparity bounds are exceeded. The second possibility is to scale profiles using a monotonic mapping function. Here, a good mapping seems to be a logarithmic function that favors small variations, which we do not need to clamp as they usually do not result in an exceeded disparity range. Nonetheless, an important observation is that some parts of D^{s} might allow for more aggressive Cornsweet profiles than others without exceeding the comfort zone. Therefore, instead of using a global method, we propose to locally scale the Cornsweet profiles to best exploit local disparity variations and to make sure that most of the lost contrast is restored. Wherever the limits are respected, these scaling factors are simply one, otherwise, we ensure that the multiplication resolves the issue of discomfort. Scaling is an acceptable operation because the Cornsweet profiles vary around zero. Deriving a scale factor for each pixel independently is easy, but if each pixel were scaled independently of the others, the Cornsweet profiles might actually disappear. In order to maintain the profile shape, scaling factors should not vary with higher frequencies than the scaled corresponding band. Hence, scale factors are computed per band.

Because the present embodiment relies on a pyramidal decomposition, Rᵢ has a two times higher resolution than Rᵢ+1. This is important because when deriving a scaling Sᵢ per band, it will automatically exhibit a reduced frequency variation. Hence, per-pixel-per-band scaling factors Sᵢ are derived that ensures that each band Rᵢ when added to D^{s} does not exceed the limit. Next, these scaling factors are “pushed down” to the highest resolution from the lowest level by always keeping the minimum scale factor of the current and previous levels. This operation results in a high-resolution scaling image S. Each S is finally divided by the number of bands to transfer (here, five). This ensures that D^{s}+Σᵢ RᵢS respects the given limits and maintains the Cornsweet profiles.

Retargeting ensures that contrast is preserved as much as possible. Although this enhancement is relatively uniform, it might not always reflect an artistic intention. For example, some depth differences between objects or particular surface details may be considered important, while other regions are judged unimportant.

To give control over the enhancement, the inventors propose a simple interface that allows an artist to specify which scene elements should be enhanced and which ones are less crucial to preserve. Precisely, the user may be allowed to specify weighting factors for the various bands which gives an intuitive control over the frequency content. Using a brush tool, the artist can directly draw on the scene and locally decrease or increase the effect. By employing a context-aware brush, edge-stopping behavior may be ensured to more easily apply the modifications.

The inventive model can also be used to improve the compression efficiency of stereo content.

FIG. 7 shows a perceptual disparity compression pipeline according to an embodiment of the invention. Assuming a disparity image as input, physical disparity may first be converted into perceived disparity. In perceptual space, disparity below one JND can be safely removed without changing the perceived stereo effect. More aggressive results are achieved when using multiple JNDs. It is possible to remove disparity frequencies beyond a certain value, e.g. 3-5 cpd.

Disparity operations like compression and re-scaling are improved by operating in the perceptually uniform space of the invention. The inventive method detects small, unperceived disparities and removes them. Additionally it can remove spatial disparity frequencies that humans are less sensitive to.

Further, when comparing the rescaling of an original image using pixel disparity and the perceptual space according to the invention, the inventive scaling compresses big disparities more, as the above-described sensitivity in such regions is small, and preserves small disparities where the sensitivity is higher. Simple scaling of pixel disparity results in loss of small disparities, flattening objects as correctly indicated by the inventive metric in the flower regions. The scaling according to the invention preserves detailed disparity resulting in smaller and more uniform differences, again correctly detected by the inventive metric.

The method for processing stereo image content may also be used to produce backward-compatible stereo that “hides” 3D information from observers without 3D equipment. Zero disparity leads to a perfectly superposed image for both eyes, but no more 3D information is experienced. More adequately, disparity must be reduced where possible to make both images converge towards the same location; hereby it appears closer to a monocular image. In particular, this technique can transform anaglyph images and makes them appear close to a monocular view or teaser image.

The implementation follows the same process as for the retargeting, but the scaled disparity is not added. In this case, the Cornsweet profiles will create apparent depth discontinuities, while the overall disparity remains low. This is naturally achieved because Cornsweet profiles are centered on zero.

The solution is very effective, and has other advantages. The reduction leads to less ghosting for imperfect shutter or polarized glasses (which is often the case for cheaper equipment). Furthermore, more details are preserved in the case of anaglyph images because less content superposes. Furthermore, it is important to realize that much of the scene structure remains understandable because the HVS is capable of propagating some of the perceived differences over the neighboring surfaces. When comparing to an image of equivalent disparity (scaled to have the same mean), almost all depth cues are lost. In contrast, to produce a similar relative depth perception, the disparity can become very large in some regions even causing problems with eye convergence. Finally, the backward-compatible approach according to the invention could be used to reduce visual discomfort for cuts in video sequences that exhibit changing disparity.

FIG. 8 shows an example of a backward compatible stereo image that provides just-enough disparity cues to perceive stereo, but minimizes visible artifacts when seen without special equipment. The need for specialized equipment is one of the main problems when distributing stereo content. For example, when printing an anaglyph stereo image on paper, the stereo impression may be enjoyed with special anaglyph glasses, but the colors are ruined for spectators with no such glasses. Similarly, observers without shutter glasses see a blur of two images when sharing a screen with users wearing adapted equipment.

The invention approaches this backward-compatibility problem in a way that is independent of equipment and image content. Starting from an arbitrary stereo content, disparity is compressed (i. e., flattened) which improves backward compatibility, and, at the same time, the inventive metric may be employed to make sure that at least a specified minimum of perceived disparity remains.

When compressing the stereo content, one can make use of the Craik-O'Brien-Cornsweet-illusion for depth (ANSTIS, S. M., AND HOWARD, I. P. 1978. A Craik-O'Brien-Cornsweet illusion for visual depth. Vision Res., 18, 213-217; ROGERS, B., AND GRAHAM, M. 1983. Anisotropies in the perception of three-dimensional surfaces. Science 221, 4618, 1409-11), which relies on removing the low-frequency component of disparity. Since humans are less sensitive for such low frequencies (FIG. 4.5), the resulting gradual disparity decay in the Cornsweet profile remains mostly invisible and apparent depth, which is induced at the disparity discontinuity is propagated by the HVS over surfaces separated by this discontinuity. One additional advantage of the Cornsweet disparity is its locality that enables apparent depth accumulation by cascading subsequent disparity discontinuities. This way the need to accumulate global disparity is avoided which improves backward-compatibility. Similar principles have been used in the past for detail-preserving tone mapping, as well as bas-relief. Note that one can also enhance high spatial frequencies in disparity (as in unsharp masking, cf. KINGDOM, F., AND MOULDEN, B. 1988. Border effects on brightness: A review of findings, models and issues. Spatial Vision 3, 4, 225-62) to trigger the Cornsweet disparity effect, but then the visibility of 3D-dedicated signal is also enhanced.

FIG. 9 shows an example of hybrid stereo images: nearby, it shows the BUDDHA; from far away, the GROG model. Hybrid images change interpretation as a function of viewing distance [Oliva et al. 2006]. They are created, by decomposing the luminance of two pictures into low and high spatial frequencies and mutually swapping them. The same procedure can be applied to stereo images by using the disparity band-decomposition and perceptual scaling according to the invention.

Converting 2D photos into 3D is never perfect. To minimize and facilitate the user interaction, one may concentrate on local discontinuities and avoid a global depth depiction. According to the invention, even localized depth representations can deliver a good scene understanding, similar to bas-relief depictions. In fact, again the Cornsweet profile seems to be a very effective shape in this context.

FIG. 10 illustrates the effect of using the Cornsweet Illusion for depth. At the top a circle with depth due to disparity and apparent depth due to Cornsweet disparity profiles in anaglyph. At the bottom the corresponding disparity profiles as well as perceived shapes are shown. The solid area depicts the total disparity, which is significantly smaller when using the Cornsweet profiles.

Rogers and Graham observed that the induced depth difference over the whole surfaces amounted up to 40% with respect to the depth difference at the discontinuity. They further measured that the effect is stronger along the horizontal (i.e. eye separation) direction, but recent results indicate no significant difference with respect to the orientation. The great advantage of the Cornsweet disparity is its locality that enables depth cascading without accumulating screen disparity as it would usually be required. The effect is remarkably strong. The invention shows that it may be exploited to enhance depth impression and to reduce physical screen disparity.

Finally, the model, once acquired, may readily be implemented and computed efficiently, allowing a GPU implementation, which was used to generate all results at interactive frame rates.

1. Computer-implemented method for processing digital stereo image content, comprising the steps:
estimating a perceived disparity of the digital stereo image content; and
processing the stereo image content, based on the estimated perceived disparity.

2. Method according to claim 1, wherein the perceived disparity is estimated from a pixel disparity of the digital stereo image content.

3. Method according to claim 2, wherein the perceived disparity of the stereo image content is estimated based on a model of a disparity sensitivity of the human visual system (HVS).

4. Method according to claim 3, wherein the disparity sensitivity depends on a disparity magnitude of the stereo image.

5. Method according to claim 3 or 4, wherein the disparity sensitivity depends on a disparity frequency of the stereo image.

6-10. (canceled)

11. Method for compressing digital stereo image content, comprising the steps of:
obtaining digital pixel disparity information for the stereo image content;
estimating a perceived disparity of the stereo image content, based on the digital pixel disparity information; and
removing disparities below a given threshold from the stereo image content, based on an absolute value of the estimated perceived disparity.

12-31. (canceled)

32. Method for generating backwards-compatible digital stereo image content conveying a stereo impression if special equipment is used but produces images that appear almost ordinary when displayed on general equipment.

33. Method according to claim 32, using Cornsweet-illusion.

34. Method according to claim 33, where the strength of Cornsweet-illusion is controlled by a disparity sensitivity model.

35. Method for stereo content enhancement by modifying disparity discontinuity profiles.

36. Method according to claim 35, where Cornsweet profiles are added to existing disparity discontinuities profiles.

37. Method according to claim 35, where disparity discontinuity profiles are enhanced by increasing magnitude of high frequency disparity signal.

38. Method according to claim 37, where disparity is enhanced using unsharp masking.

39. (canceled)

40. Computer-readable medium, comprising digital stereo image content processed by a method according to claim 1.

41. (canceled)

42. Method for calibrating stereo equipment, comprising the steps:
generating a visual stimulus;
generating a stereo view of the stimulus;
presenting, using the stereo equipment, the stereo view of the stimulus to a user;
obtaining a user response to the stereo view;
calculating disparity sensitivity data, based on the user response; and
calibrating the stereo equipment, based on the acquired sensitivity data.

43-45. (canceled)
